(19) United States
(12) Patent Application Publication
(10) Pub. No.: US 2004/0261395 A1
(43) Pub. Date: Dec. 30, 2004

(54) Reliable LNG vaporizer

(76) Inventor: Gerald E. Engdahl, Wheaton, IL (US)

Correspondence Address: GERAL ENGDAHL, 1425 OXFORD LANE, WHEATON, IL, 60187, US

(21) Appl. No.: 10/869,086

(22) Filed: Jun. 16, 2004

Related U.S. Application Data
(60) Provisional application No. 60/482,405, filed on Jun. 25, 2003.

(51) Int. Cl. F02C 3/22; F28F 13/00

(52) U.S. Cl. 60/39.465; 60/722; 165/146

(57) ABSTRACT

An apparatus for vaporizing liquefied natural gas (LNG) is disclosed. The apparatus comprises an LNG side with a plurality of heat transfer circuits and a heating medium side with a plurality of passages within a trough like containment. The vaporizer is designed for high heat transfer rates and reduced thermal stresses. The vaporizer can be brought on line quickly, and can utilize sea water and other fluids as the heating medium.

### RELATED APPLICATIONS

This application claims domestic priority from provisional application Ser. No. 60/482,405, filed Jun. 25, 2003, the entire disclosure of which is incorporated herein by reference.

### FIELD OF THE INVENTION

The present invention relates to an apparatus for vaporizing liquefied natural gas (LNG). More specifically, the present invention relates to an apparatus using a heating medium such as sea water to vaporize LNG with high heat transfer rates.

### BACKGROUND OF THE INVENTION

Liquefied natural gas is stored at many locations throughout the world. The LNG is used when a local source of natural gas is not available or as a supplement to local and regional sources. Liquefied natural gas is typically stored at low pressure in the liquid state at cold temperatures. The LNG is usually pumped to a pressure that is slightly above the pressure of the natural gas distribution pipeline. The high pressure liquid is vaporized and sent to the pipeline. The vaporizers can be fired type vaporizers or energy efficient vaporizers which utilize an ambient temperature heating medium such as sea water or river water.

Open rack, shell and tube and intermediate fluid vaporizer fluid vaporizers are generally used to vaporize LNG using sea water as the heating medium. These vaporizers are all subject to thermal stresses which can damage the vaporizer and lead to failure of the apparatus. The present invention discloses a vaporizer less susceptible to thermal stresses, provides a vaporizer which can be brought on line quickly, is economic and reliable, and can utilize sea water and other fluids as the heating medium.

United States Patent MECHANISM FOR FIRING GAS TURBINES WITH LIQUEFIED NATURAL GAS U.S. Pat. No. 5,400,588 by Yamane et al. discloses an apparatus for firing a gas turbine with LNG. Refrigeration recovered from the LNG is used to pre-cool gas turbine inlet air. The Yamane patent includes a LNG vaporizer. The vaporizer has heat exchanger tubes arranged for accumulating ice in a uniform manner. The tubes near the LNG inlet are insulated. The Yamane vaporizer accumulates ice on the tubes during certain periods and ice is melted during other periods. The Yamane vaporizer functions and is designed as a thermal energy storage apparatus and part of the overall mechanism for firing gas turbines with LNG. LNG vaporizers are included in several additional gas turbine inlet air pre-cooling patents. These gas turbine inlet air pre-cooling patents do not teach or suggest the technology of the present specification.

Another type of LNG vaporizer is the submerged combustion LNG vaporizer (SCV). The SCV includes a heat transfer coil installed in a water bath. The water bath is equipped with submerged combustion burners firing into the water bath. The burner system includes a large blower for providing combustion air. The submerged combustion burner provides heat and turbulence for high heat transfer rates. In some applications a heated fluid is circulated through the bath providing heat without fuel combustion. The air blower can be utilized to add turbulence for increased heat transfer. The SCV using seawater as the heat source for vaporizing LNG lacks the baffling and other features for effective heat transfer. The SCV includes the heat transfer surface area and the water bath for vaporizing LNG, but does not include the arrangement for effective vaporization as set forth in the present invention.

### OBJECT OF THE INVENTION

It is accordingly, an object of the present invention to provide a novel, economical arrangement to reliably vaporize LNG.

A second objective of the present invention is to directly vaporize LNG with energy efficient heating mediums such as ambient sea water, river water or other heat sources.

A third objective of the present invention is to provide a heating medium arrangement to obtain high heat transfer rates including cross flow heat transfer.

A forth objective of the present invention is to provide a vaporizer which can be started quickly and operate continuously with stable outlet LNG flows over a range of LNG flow rates.

A fifth objective of the present invention is to provide a vaporizer where the spacing of the colder heat transfer tubes containing LNG can be configured to accommodate icing.

A sixth objective of the present invention is to accommodate the heating and vaporizing of many cold fluids utilizing various heating mediums.

A seventh objective of the present invention is to operate with a stable outlet gas composition essentially the same as the inlet LNG composition.

An eighth objective of the present invention is to provide an apparatus for vaporizing LNG at high operating pressures.

A ninth objective of the present invention is to provide a vaporizer with features which can facilitate cleaning of the heating medium side.

A tenth objective of the present invention is to provide a vaporizer with a LNG heat transfer circuit tube bundle which could be removed.

An eleventh objective of the present invention is to provide a vaporizer with design flexibility to meet specific system performance and operational requirements.

A twelfth objective of the present invention is to provide a vaporizer with reduced potential for LNG liquid carryover for increased vaporizer reliability.

A thirteenth objective of the present invention is to provide a vaporizer with reduced thermal stresses from heat transfer tube movement for increased vaporizer reliability.

A fourteenth objective of the present invention is to provide a vaporizer with high heat transfer rates without using auxiliary air to promote turbulence.

A fifteenth objective of the present invention is to directly vaporize LNG with energy efficient waste heat sources.

A sixteenth objective of the present invention is to provide a vaporizer which can be installed below grade, above grade or partly below grade.

A seventeenth objective of the present invention is to provide a vaporizer which can be installed on ships, offshore locations, or onshore locations.

An eighteenth objective of the present invention is to provide a vaporizer which has a compact footprint.

A nineteenth objective of the present invention is to provide means for controlling the vaporizer.

A twentieth objective of the present invention is to provide an arrangement which helps keep particles in the heating medium from settling within the heat transfer area.

A twenty first objective of the present invention is to vaporize LNG with seawater without intermediate fluids.

A twentieth second objective of the present invention is to provide an arrangement where iced tubes have heating medium flow.

### SUMMARY OF THE INVENTION

In accordance with one aspect of the present invention, a LNG vaporizer includes a trough like containment, at least one LNG inlet header configured to receive LNG, at least one vaporized LNG outlet header, a plurality of heat transfer circuits wherein the heat transfer circuit consists mainly of tubes connected in series in a serpentine layout, the heat transfer circuits having bar baffles, one end of a circuit connects to a LNG inlet header, the other end of a circuit connects to a vaporized LNG outlet header, at least one heating medium inlet arrangement configured to receive a heating medium, at least one heating medium outlet arrangement, wherein at least a portion of the bar baffles are arranged to provide heating medium flow passages in a generally serpentine flow path, the flow passages connecting the heating medium inlet and outlet arrangements within the trough like containment.

In accordance with another aspect of the present invention, a LNG vaporizer includes a trough like containment, at least one LNG inlet header configured to receive LNG, at least one vaporized LNG outlet header, a plurality of heat transfer circuits wherein the heat transfer circuit consists mainly of tubes connected in series in a serpentine layout, the heat transfer circuits having bar baffles, one end of a circuit connects to a LNG inlet header, the other end of a circuit connects to a vaporized LNG outlet header, at least one heating medium inlet arrangement configured to receive a heating medium, at least one heating medium outlet arrangement, at least one heating medium flow reversing plenum, wherein at least a portion of the bar baffles are arranged to provide heating medium flow passages in a generally serpentine flow path, the flow passages connecting the heating medium inlet and outlet arrangements within the trough like containment.

In accordance with a preferred embodiment, various fluids are heated and vaporized in the vaporizer or are heated in the vaporizer or are cooled in the vaporizer or are condensed in the vaporizer.

Various types of baffles can be utilized in the vaporizer.

The vaporizer includes at least one dummy shape.

Sea water, river water, water glycol mixtures, heated water, ambient water, hydrocarbons, air and other fluids and heat sources can be utilized as the vaporizer heating medium.

In accordance with a further aspect of the present invention, a LNG vaporizer includes a trough like containment, a plurality of generally serpentine heat transfer circuits containing LNG and having support baffles, a plurality of dummy shapes, a heating medium input, at least one heating medium flow reversing plenum, wherein at least a portion of the baffles are arranged to provide cross flow heating medium flow passages in a generally serpentine flow path.

In accordance with yet another aspect of the present invention, a LNG vaporizer includes a plurality of heat transfer circuits wherein the heat transfer circuit consists mainly of tubes connected in series in a serpentine layout, the spacing between selected heat transfer tubes is increased to accommodate tube icing, and a heating medium trough like containment.

In accordance with a still further aspect of the present invention, a LNG vaporizer includes a plurality of heat transfer circuits, a heating medium within a trough like containment and at least one heating medium flow reversing plenum positioned within the trough like containment.

In accordance with a further aspect of the present invention, a LNG vaporizer includes a plurality of heat transfer circuits, a heating medium within a trough like containment, a removable containment cover and heating medium cleaning means.

In accordance with a yet further aspect of the present invention, a LNG vaporizer includes a plurality of rows of heat transfer circuits, the heat transfer circuits connected to LNG headers and having baffles, the baffles being positioned on each row of heat transfer circuits as that row of heat transfer circuits is assembled to the LNG headers.

In accordance with a still further aspect of the present invention, a LNG vaporizer includes a warm fluid being mixed with the incoming LNG to warm the temperature of the resultant mixture entering the vaporizer.

Other features and advantages are inherent in the device claimed and disclosed or will become apparent to those skilled in the art from the following detailed description and its accompanying drawings.

### BRIEF DESCRIPTION OF THE DRAWINGS

FIG. 1 illustrates a side elevation view showing an example of the vaporizer pertaining to the present invention.

FIG. 2 illustrates a partial plan view showing an example of the vaporizer pertaining to the present invention with generally cross flow heating medium passages. The cover is removed.

FIG. 3 illustrates an elevation view showing a row with two heat transfer circuits pertaining to the present invention.

FIG. 4 illustrates a partial plan view showing an example of the vaporizer pertaining to the present invention with completely cross flow heating medium passages. The cover is removed.

FIG. 5 illustrates a sketch of a bar baffle.

FIG. 6 illustrates a portion of two rows of heat transfer circuits.

### DETAILED DESCRIPTION OF THE INVENTION

The present invention discloses a device designed for the effective and reliable vaporization of LNG. Serpentine heat transfer circuits are configured with novel baffle and heating medium flow arrangements to provide high heat transfer rates and low thermal stresses. LNG can be vaporized in direct heat exchange with seawater and other heating mediums. The vaporizer includes a LNG side (LNG within tubes), and a heating medium side.

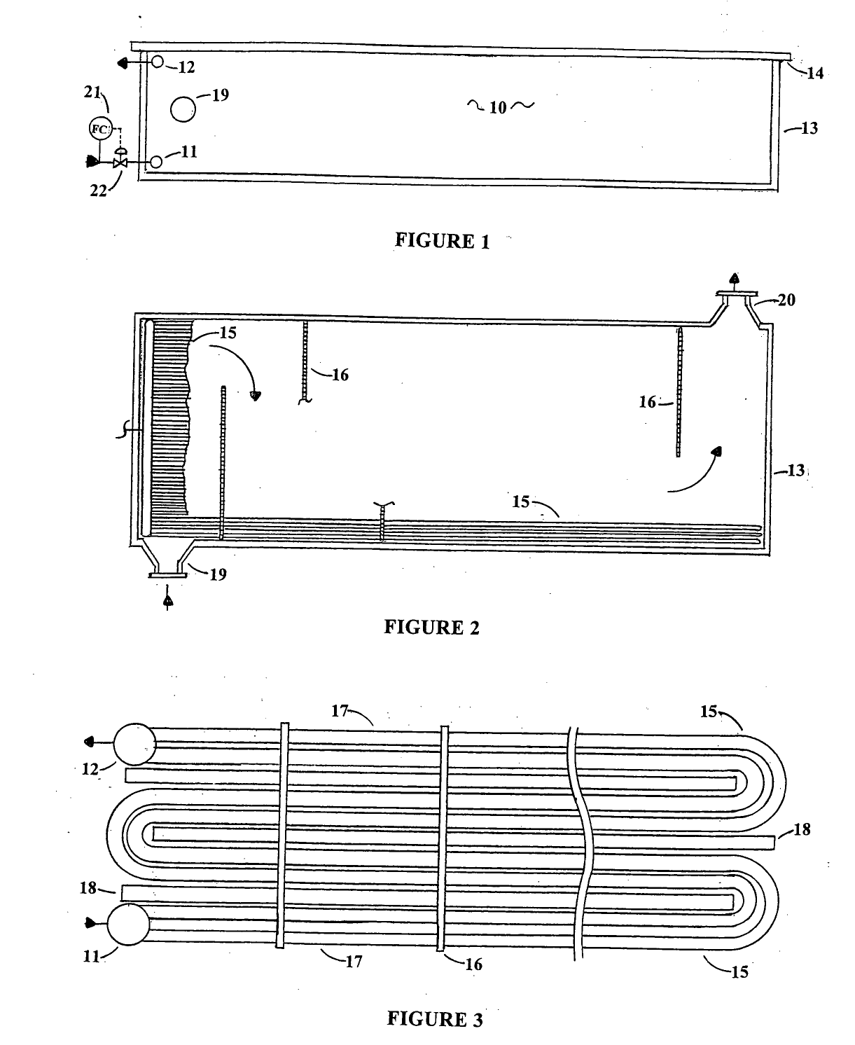

Referring to FIG. 1, a vaporizing device 10 embodying features of this invention is illustrated. The vaporizing device 10 has a LNG inlet header 11, a LNG outlet header 12, and a trough like heating medium containment 13 with a removable cover 14. The LNG inlet header receives LNG from pumps, generally at high pressure. Multiple rows of heat transfer circuits 15 are connected to the LNG headers to form a heat transfer circuit bundle. The heat transfer circuits 15 are shown in plan view FIG. 2. FIG. 2 is a plan view of the vaporizer with the cover 14 removed. Vertical bar baffles 16 help support the heat transfer circuits and appropriately located provide serpentine heating medium flow passages. Rod baffles and other types of baffles can also be utilized to support the heat transfer circuits and provide flow passages for the heating medium. A sketch of bar baffle 16 is shown in FIG. 5. The bar baffles are installed during assembly of the heat transfer bundle. The bar baffles to be positioned on a heat transfer circuit row are installed on that row as that row is being assembled to the LNG headers.

An elevation view of one row with two heat transfer circuits is shown in FIG. 3. Each heat transfer circuit 15 is a four pass circuit and consists of tubes 17 containing LNG connected in a serpentine arrangement. The tubes 17 may have extended surface area. Bar baffles 16 provide support. Each serpentine heat transfer circuit is connected on one end to LNG inlet header 11 and on the other end to LNG outlet header 12. The heat transfer circuits can be provided with inlet orifices and core busters for LNG distribution control and increased heat transfer. Referring to FIG. 3, the heat transfer circuit includes several dummy shapes 18 not containing LNG. The dummy shapes 18 are utilized to increase the tube U bend rolling radius, increase the heating medium velocity, reduce heating medium by passing and other considerations. The dummy shapes are generally enclosed, but could contain the heating medium. Dummy shapes can have circular cross sections or can be constructed in other configurations. The dummy shapes can be arranged to provide heating medium horizontal baffling. Each row of heat transfer circuits can be offset from the adjacent row of heat transfer circuits in the vertical direction to provide a triangular pitch type of layout. The bar baffle shown in FIG. 5 would be used in a triangular pitch type of layout. Square pitch and other types of layouts can be used. The heat transfer circuit tube spacing can be adjusted to provide space for tube icing.

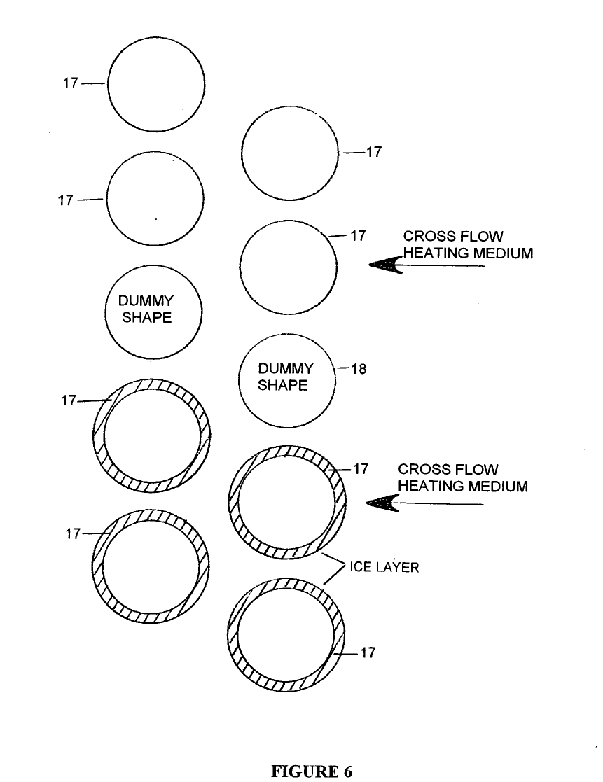

FIG. 6 shows a portion of two rows of heat transfer circuits. The lower tubes 17 are near the cold LNG inlet and are shown with a layer of ice. LNG vaporizers (this invention, shell and tube vaporizers and others) using seawater as the heating medium in direct heat exchange with the LNG surface will have an ice layer on the cold surface area near the LNG inlet. The tubes 17 above the dummy shape 18 are warmer without an ice layer. The dummy shapes shown in FIG. 6 are one of several possible dummy shape configurations. The vertical tube pitch for the lower colder iced tubes is greater than the tube pitch distance between the upper warmer tubes. The gap for cross flow heating medium flow is the same for the lower iced tubes as the gap for the upper tubes without ice. The iced tubes have heating medium flow. The rows of heat transfer circuits shown in FIG. 6 have a triangular pitch type of layout. The heat transfer circuit tube spacing can also be adjusted to allocate the heating medium flow. The heat transfer circuit bundle can be designed to be removable.

Referring to FIG. 2, the heating medium side includes heating medium inlet arrangement 19 and heating medium outlet arrangement 20. Heating medium plenums can be part of the heating medium inlet and outlet arrangements. The heating medium flow path proceeds from the heating medium inlet arrangement 19, to a plurality of passages within the heating medium containment defined by the positioning of the bar baffles 16, to the heating medium outlet arrangement 20. The heating medium flow through the plurality of passages follows a serpentine flow path. The heating medium flow in each flow passage in FIG. 2 is in a cross flow and parallel flow direction and is determined by the baffle arrangement.

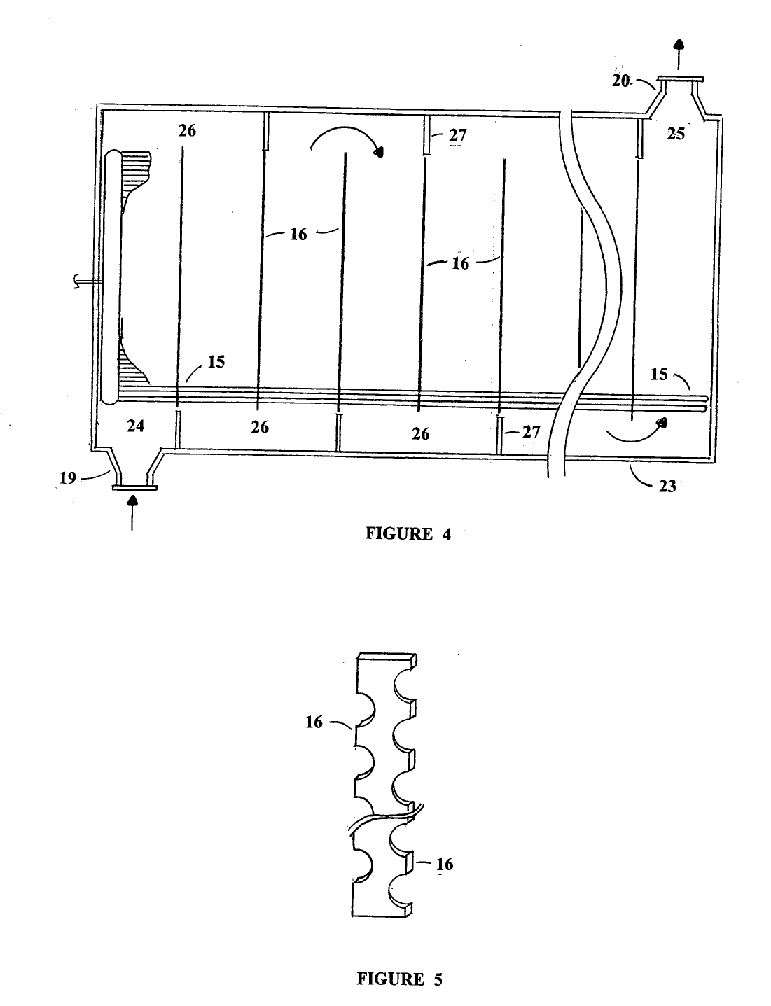

The trough like heating medium containment 23 shown in FIG. 4 includes heating medium inlet plenum 24, heating medium outlet plenum 25 and heating medium flow reversing plenums 26. Plenum 24 is part of heating medium inlet arrangement 19. Plenum 25 is included with heating medium outlet arrangement 20. Partitions 27 are included in the heating medium containment 23 and are positioned to define individual plenums. Bar baffles 16 are positioned to provide a completely cross flow heating medium passage. The heating medium reverses flow in the flow reversing plenums 26. The heating medium flows through the heating medium containment in a serpentine flow path. The heating medium contacts the heat transfer circuits in a completely cross flow heat transfer arrangement. The cross flow heating medium configuration in FIG. 4 results in more uniform heat transfer at high heat transfer rates. The ice formation on tubes is more uniform. If foreign material is present in the heating medium, turbulence in the completely cross flow exchanger can reduce the quantity of settled material within the heat transfer circuit bundle. The exchanger will have less fouling.

In the flow arrangement of FIG. 2, the heating medium flows perpendicular to the heat transfer circuits for a portion of the heating medium flow pass resulting in cross flow heat transfer for that portion of the pass. Where the heating medium changes flow direction a portion of the heating medium flow is parallel to the heat transfer circuits resulting in parallel flow heat transfer. In the heating medium flow arrangement of FIG. 4, the heating medium flows perpendicular to the heat transfer circuits the entire length of the heating medium flow passage for completely cross flow heat transfer. Heating medium flow reversal occurs in the flow reversing plenums. Heating medium baffle leakage will occur in both the FIG. 2 flow arrangement and the FIG. 4 completely cross flow arrangement.

End baffle plates are installed at each end of the heat transfer circuit bundle to reduce the quantity of heating medium bypassing the heat transfer surface area. The end baffle plates are inserted vertically between the rows of heat transfer circuits. They are installed generally perpendicular to the heating medium flow direction and make contact with the walls of the containment structure. Header baffle inserts are positioned between the LNG hearers and the containment structure to also reduce heating medium bypassing.

The vaporizer design can accommodate the reversal of heating medium flow. Reversing the heating medium flow can assist in the vaporizer cleaning operation and have other potential benefits.

Some vaporizer variations follow:

The containment shape can be straight, rounded or both.

The containment shape can have one or more removable covers.

The containment position can be horizontal, at a slant or at other positions.

The vaporizer can include more than one heat source and more than one heating medium.

Heating medium and LNG control devices can be provided within the apparatus.

The apparatus can be located below grade or above grade or partly below grade.

The heat transfer circuits can have multiple headers.

The serpentine heat transfer circuit can have multiple passes or two passes (like an exchanger U-tube).

The vaporizer has features which facilitate cleaning of the heating medium side. A dirty heating medium side will reduce the heat transfer rates. Several options are available for cleaning and maintaining the heating medium side including the following:

Foreign material in the heating medium can settle and accumulate in vaporizer plenum areas.

Provisions can be included to remove foreign material from the plenum areas.

Reverse the heating medium flow direction.

Slowly pulse the heating medium flow.

Reduce the LNG and heating medium flow rates to cool more of the heat transfer circuit area.

Use a high pressure cleaning lance inserted between rows of heat transfer circuits (cover removed).

Periodically during operation, alternately for a short time, open bottom drains to temporarily increase the heating medium velocity and help flush the bottom area.

Remove the cover and the heat transfer circuit bundle for access for cleaning.

Vaporizer systems would generally benefit from maintaining chlorine residual in the heating medium (the chlorine helps to maintain a cleaner system).

An assembly sequence for the heat transfer circuit bundle follows:

Drill the tube holes in LNG headers.

Prepare a jig which will hold the headers in place and the bar baffles in place. Locate and clamp the outer bar baffles in place. Position and attach the dummy shapes in place.

Position the first row of serpentine coils into the outer bar baffles and using clamps secure in position. Weld each coil end into the headers. Position and attach a set of interior bar baffles.

Position the second row of serpentine coils and dummy shapes into the interior bar baffles and using clamps secure in position. Weld each coil end into the headers.

Position another set of interior bar baffles in place. Fasten them to the existing interior bar baffles.

Continue above procedure to assemble each row of serpentine coils and each row of bar baffles.

The present invention is designed for using sea water and other ambient waters as energy efficient heat sources. Vaporizers using ambient sea water directly as the heating medium will ice. The vaporizer, designed for icing, can use seawater to vaporize LNG in direct contact heat exchange with the heat transfer surface area. The LNG vaporization can be accomplished without intermediate fluids. The vaporizer has the flexibility to also use energy efficient waste heat and other heat sources for vaporizing LNG. The heat source fluid in these applications can generally be utilized in direct contact with the vaporizer heat exchanger surface. The heat source can be ambient, warm, or hot water, a water glycol solution, or other fluids.

The present invention is described as a LNG vaporizer which inherently is meant to include the heating and vaporization of liquid and the heating of vapor.

A means for controlling the LNG side of vaporizer 10 is indicated in FIG. 1. The control includes a flow controller 21 sending a control signal to flow control valve 22. Flow control valve 22 regulates the flow of LNG to maintain the flow setting of flow controller 21. An alternate control scheme would utilize a pressure controller on the LNG side sending a control signal to flow control valve 22. The signal from an LNG side pressure controller could also be utilized to set the flow on LNG flow controller 21. Another control scheme includes LNG outlet temperature control to vary the flow of a LNG bypass stream in conjunction with means to vary the flow of the main stream. A variable speed LNG pump can also be used to control the LNG flow.

The heating medium side control system can include:

Flow control

Temperature of heating medium

Temperature of vaporized gas

Pressure control

Manual valves set to balance the flow between several vaporizers

Temperature control to vary the flow of a bypass stream of the heating medium in conjunction with controls to vary the flow of the main heating medium stream.

The controllers described for the present invention can be direct mounted controllers or part of a control loop including a transmitter or transmitter element and a controller. Additional controls and safety devices would be included on a LNG vaporizer for a specific application, but have been omitted on the patent drawings.

The LNG vaporizer design for a specific application includes an analysis of heat exchanger performance. The analysis includes heat transfer, velocity, pressure drop, fluid and material properties and icing considerations. The vaporizer can be configured to provide high heat transfer rates. Examples of the vaporizer inherent design flexibility include the heat transfer circuit spacing and arrangement, the tube size, the length of each pass, the number of passes, the dummy shape size and arrangement, the support, baffle and plenum arrangement, the containment arrangement, the control arrangement, the extended surface area arrangement and inlet and outlet arrangements.

Many LNG vaporizers are required to operate at high pressures and have high design pressures. These vaporizers can have design pressures exceeding 2000 psig. The LNG header and heat transfer circuit arrangement of the present invention is appropriate for high pressure designs.

Liquefied natural gas pressure drop in the long heat transfer circuits of the present invention provides balanced flow distribution and stable flows during design and normal turndown conditions. The long serpentine heat transfer circuits have reduced potential for liquid carryover.

The outlet gas composition of the present invention during operation is essentially the same as the inlet liquid composition. The LNG inlet header arrangement and size limit the accumulation of high molecular weight hydrocarbon liquids which could affect the composition of the vaporized gas. The outlet gas composition is stable.

LNG entering the vaporizer is at cryogenic temperatures. Many heating mediums will form ice on the outside of the heat transfer circuit tubes connected to the LNG inlet header. An ejector nozzle positioned in the LNG inlet piping leading to the vaporizer LNG inlet header can provide a means of warming the temperature of the LNG entering the vaporizer. The ejector induces a portion of the warm vaporizer discharge into the incoming cold liquid. The vapor is condensed by direct contact with the cold liquid. The temperature of the resultant stream is warmer. The vaporizer tube icing will be reduced. Fluids from other sources can also be mixed with the incoming LNG to warm the LNG stream.

The present invention discloses a LNG vaporizer with operational advantages. The serpentine design provides flexibility to accommodate tube movement during temperature changes. Vaporizer expansion joints are not required. Individual heat transfer tubes and circuits can cool down or warm up at different rates without high thermal stresses. The serpentine heat transfer circuit is less susceptible to thermal stress resulting from exchanger surface area temperature differences that can be created by surface area fouling or icing. The vaporizer can be quickly cooled down. The vaporizer configuration and flexibility permits start up to proceed from cool down to operational status quickly. The vaporizer shutdown can be rapid. The configuration and control system provide reliable continued operation with stable flow and a stable LNG composition.

The present invention can be utilized at LNG import terminals, LNG peak shaving and satellite facilities. The present invention can be utilized to heat and or vaporize and or condense and or cool LPG, ethane, carbon dioxide, liquid nitrogen, propane, ammonia, and other fluids. The apparatus could be used on a LNG ship to vaporize the LNG. The vaporized LNG would flow from the ship directly to gas mains on shore. The vaporizer can be installed onshore or offshore. High vaporization capacities are available in a single, compact unit. The compact unit has a small footprint with a low profile. These characteristics are advantageous for offshore platform and ship applications.

The present invention can be used to provide cooling duty. It could be used at LNG fueled gas turbine installations. The refrigeration available in the LNG may be used to pre-cool the gas turbine inlet combustion air or provide cooling for other applications. The inlet air cooler is the heat source for vaporizing the LNG.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. The details of the apparatus may be varied substantially without departing from the spirit of the invention, and the exclusive use of all modifications which come within the scope of the appended claims is reserved.

What is claimed:

1. A LNG vaporizer comprising:
a trough like containment;
at least one LNG inlet header configured to receive LNG;
at least one vaporized LNG outlet header;
a plurality of heat transfer circuits wherein the heat transfer circuit consists mainly of tubes connected in series in a serpentine layout, the heat transfer circuits having bar baffles, one end of a circuit connects to a LNG inlet header, the other end of a circuit connects to a vaporized LNG outlet header;
at least one heating medium inlet arrangement configured to receive a heating medium;
at least one heating medium outlet arrangement;
wherein at least a portion of the bar baffles are arranged to provide heating medium flow passages in a generally serpentine flow path, the flow passages connecting the heating medium inlet and outlet arrangements within the trough like containment.

2. The LNG vaporizer of claim 1, wherein various fluids are heated and vaporized in the vaporizer or are heated in the vaporizer or are cooled in the vaporizer or are condensed in the vaporizer.

3. The LNG vaporizer of claim 1, wherein various types of baffles are utilized.

4. The LNG vaporizer of claim 1, wherein the vaporizer includes at least one dummy shape.

5. The LNG vaporizer of claim 1, wherein sea water, river water, water glycol mixtures, heated water, ambient water, hydrocarbons, air and other fluids and heat sources are utilized as the heating medium.

6. A LNG vaporizer comprising:
a trough like containment;
at least one LNG inlet header configured to receive LNG;
at least one vaporized LNG outlet header;
a plurality of heat transfer circuits wherein the heat transfer circuit consists mainly of tubes connected in series in a serpentine layout, the heat transfer circuits having bar baffles, one end of a circuit connects to a LNG inlet header, the other end of a circuit connects to a vaporized LNG outlet header;
at least one heating medium inlet arrangement configured to receive a heating medium;
at least one heating medium outlet arrangement;
at least one heating medium flow reversing plenum;
wherein at least a portion of the bar baffles are arranged to provide heating medium flow passages in a generally serpentine flow path, the flow passages connecting the heating medium inlet and outlet arrangements within the trough like containment.

7. The LNG vaporizer of claim 6, wherein various fluids are heated and vaporized in the vaporizer or are heated in the vaporizer or are cooled in the vaporizer or are condensed in the vaporizer.

8. The LNG vaporizer of claim 6, wherein various types of baffles are utilized.

9. The LNG vaporizer of claim 6, wherein the vaporizer includes at least one dummy shape.

10. The LNG vaporizer of claim 6, wherein sea water, river water, water glycol mixtures, heated water, ambient water, hydrocarbons, air and other fluids and heat sources are utilized as the heating medium.

11. A LNG vaporizer comprising:
a trough like containment;
a plurality of generally serpentine heat transfer circuits containing LNG and having baffle support;
a plurality of dummy shapes;
a heating medium input;
at least one heating medium flow reversing plenum;
wherein at least a portion of the baffles are arranged to provide cross flow heating medium flow passages in a generally serpentine flow path.

12. A LNG vaporizer comprising:
a LNG vaporizer with a plurality of heat transfer circuits consisting mainly of tubes connected in series in a serpentine layout;
the spacing between selected heat transfer tubes increased to accommodate tube icing;
and a heating medium trough like containment.

13. A LNG vaporizer comprising:
a LNG vaporizer with a plurality of heat transfer circuits;
a heating medium within a trough like containment;
a removable trough like containment cover system and heating medium cleaning means.

14. A LNG vaporizer comprising:
a plurality of rows of heat transfer circuits;
the heat transfer circuits connected to LNG headers and having baffles;
at least a portion of the baffles being positioned on each row of heat transfer circuits as that row of heat transfer circuits is assembled to the LNG headers.

15. A LNG vaporizer comprising:
a LNG vaporizer where a warm fluid is mixed with the incoming LNG to warm the temperature of the resultant mixture entering the vaporizer.
